(19) United States
(12) Patent Application Publication
(10) Pub. No.: US 2018/0266489 A1
(43) Pub. Date: Sep. 20, 2018

(54) SELF-CONTAINED OIL-LUBRICATED BEARING BRACKET SYSTEM

(71) Applicant: GM GLOBAL TECHNOLOGY OPERATIONS LLC, Detroit, MI (US)

(72) Inventors: Thomas Filipucci, Commerce Township, MI (US); Arthur C. Valverde, Macomb, MI (US)

(21) Appl. No.: 15/462,010

(22) Filed: Mar. 17, 2017

(51) Int. Cl. F16C 33/66; B60R 17/02

(52) U.S. Cl. CPC F16C 33/6659; F16C 2326/20; F16C 33/664; B60R 17/02

(57) ABSTRACT

A self-contained oil lubricated bearing bracket system for a vehicle includes a bracket component having a body including an inner surface defining, at least in part, a first opening, a second opening, and an interior portion defining, at least in part, a lubricant reservoir. A bearing is mounted to the bracket component. The bearing includes a plurality of bearing elements, at least one of the plurality of bearing elements is arranged in the lubricant reservoir.

### FIELD OF THE INVENTION

The subject disclosure relates to the art of vehicles and, more particularly, to a self-contained oil lubricated bearing bracket system for a vehicle.

### BACKGROUND

Vehicles employ a large number of bearings that rotatably support various rotating components such as shafts, axles, and the like. During operation, bearings require lubrication to reduce kinetic friction and prolong an overall operational life. Lubrication is provided through jets or streams of lubricant such as for cam shaft bearings and crankshaft bearings, or through packed grease such as wheel bearings. Other bearings, such as bearings with a sacrificial seal, may contain an amount of lubricant trapped by the seal.

Bearings with a sacrificial seal require periodic inspection and maintenance in order to ensure proper operation. Inspection and replacement frequency is increased when a sacrificial grease bearing is located in a high contamination and/or corrosive environment such as the underside of a vehicle. Failure to periodically inspect and/or replace a sacrificial grease bearing may lead to a bearing failure, which could then cause failure of a rotating component. Accordingly, it is desirable to provide a lubrication system for a bearing located in a high contamination/corrosive environment that requires less frequent inspection and/or maintenance.

### SUMMARY OF THE INVENTION

In accordance with an exemplary embodiment, a self-contained oil lubricated bearing bracket system for a vehicle includes a bracket component having a body including an inner surface defining, at least in part, a first opening, a second opening, and an interior portion defining, at least in part, a lubricant reservoir. A bearing is mounted to the bracket component. The bearing includes a plurality of bearing elements, at least one of the plurality of bearing elements is arranged in the lubricant reservoir.

In addition to one or more of the features described above or below, or as an alternative, further embodiments could include wherein the bearing includes an outer race fixedly mounted to the inner surface, and an inner race, the plurality of bearing elements being arranged between the outer race and the inner race.

In addition to one or more of the features described above or below, or as an alternative, further embodiments could include a first snap ring extending annularly about a first side of the bearing and a second snap ring extending about a second, opposing side of the bearing, the first snap ring and the second snap ring retaining the bearing in the bracket component.

In addition to one or more of the features described above or below, or as an alternative, further embodiments could include a first seal extending about the first opening and a second seal extending about the second opening.

In addition to one or more of the features described above or below, or as an alternative, further embodiments could include wherein at least one of the first seal and the second seal comprises one of a lip seal and a cartridge seal.

In addition to one or more of the features described above or below, or as an alternative, further embodiments could include wherein at least one of the first seal and the second seal comprises a cartridge seal including a slinger.

In addition to one or more of the features described above or below, or as an alternative, further embodiments could include a vent and fill cap arranged in the bracket component.

In addition to one or more of the features described above or below, or as an alternative, further embodiments could include an amount of lubricant arranged in the lubricant reservoir.

In addition to one or more of the features described above or below, or as an alternative, further embodiments could include wherein the lubricant reservoir includes a first reservoir portion and a second reservoir portion, the first reservoir portion being fluidically connected with the second reservoir portion.

In accordance with another aspect of an exemplary embodiment, a vehicle includes a frame, a body supported by the frame, and a powertrain supported by the frame and at least partially enclosed by the body. The powertrain includes a prime mover and a transmission connected to the prime mover. The transmission includes at least one output shaft, and a self-contained oil lubricated bearing bracket system rotatably supporting the at least one output shaft. The self-contained oil lubricated bearing bracket system includes a bracket component including a body having an inner surface defining, at least in part, a first opening, a second opening, and an interior portion defining, at least in part, a lubricant reservoir. A bearing is mounted to the bracket component. The bearing includes a plurality of bearing elements. At least one of the plurality of bearing elements is arranged in the lubricant reservoir.

In addition to one or more of the features described above or below, or as an alternative, further embodiments could include wherein the bearing includes an outer race fixedly mounted to the inner surface, and an inner race, the plurality of bearing elements being arranged between the outer race and the inner race.

In addition to one or more of the features described above or below, or as an alternative, further embodiments could include a first snap ring extending annularly about a first side of the bearing and a second snap ring extending about a second side of the bearing, the first snap ring and the second snap ring retaining the bearing in the bracket component.

In addition to one or more of the features described above or below, or as an alternative, further embodiments could include a first seal extending about the first opening and a second seal extending.

In addition to one or more of the features described above or below, or as an alternative, further embodiments could include wherein at least one of the first seal and the second seal comprises one of a lip seal and a cartridge seal.

In addition to one or more of the features described above or below, or as an alternative, further embodiments could include wherein at least one of the first seal and the second seal comprises a cartridge seal including a slinger.

In addition to one or more of the features described above or below, or as an alternative, further embodiments could include a vent and fill cap arranged in the bracket component.

In addition to one or more of the features described above or below, or as an alternative, further embodiments could include an amount of lubricant arranged in the lubricant reservoir.

In addition to one or more of the features described above or below, or as an alternative, further embodiments could include wherein the lubricant reservoir includes a first reservoir portion arranged on a first side of the bearing and a second reservoir portion arranged on a second, opposing side of the bearing, the first reservoir portion being fluidically connected with the second reservoir portion.

In addition to one or more of the features described above or below, or as an alternative, further embodiments could include wherein the at least one output shaft comprises an intermediate drive shaft (IDS).

In addition to one or more of the features described above or below, or as an alternative, further embodiments could include wherein the self-contained oil lubricated bearing bracket system is fixedly mounted to the prime mover.

The above features and advantages and other features and advantages of the exemplary embodiments are readily apparent from the following detailed description when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 depicts a vehicle including a self-contained oil lubricated bearing bracket system, in accordance with an exemplary embodiment;

FIG. 2 depicts a power train of the vehicle of FIG. 1 including a self-contained oil lubricated bearing bracket system, in accordance with an exemplary embodiment;

FIG. 3 depicts the self-contained oil lubricated bearing bracket system of FIG. 2, in accordance with an exemplary embodiment; and

FIG. 4 is a partial cross-sectional view of the self-contained oil lubricated bearing bracket system of FIG. 3, in accordance with an exemplary embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

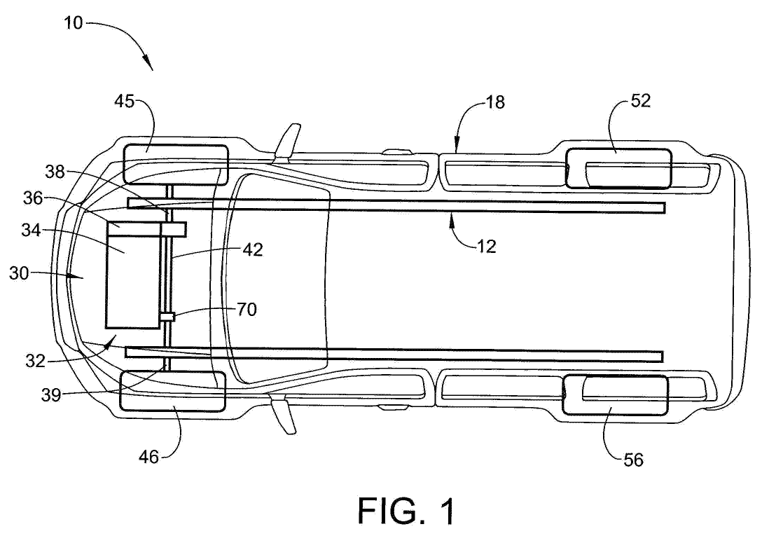

A vehicle, in accordance with an exemplary embodiment, is indicated generally at 10 in FIG. 1. Vehicle 10 includes a frame 12 that supports a body 18. Vehicle 10 further includes a powertrain 30 that may be partially enclosed by body 18. Powertrain 30 includes a prime mover 32 that takes the form of a motor 34. Motor 34 may comprise an internal combustion engine, an electric motor, a hybrid motor, or the like. A transmission 36 is operatively connected to motor 34. In the exemplary embodiment shown, powertrain 30 is mounted transversely within body 18 such that vehicle 10 is formed with a front wheel drive configuration. It is to be understood that vehicle 10 may also be formed with an all or four wheel drive configuration.

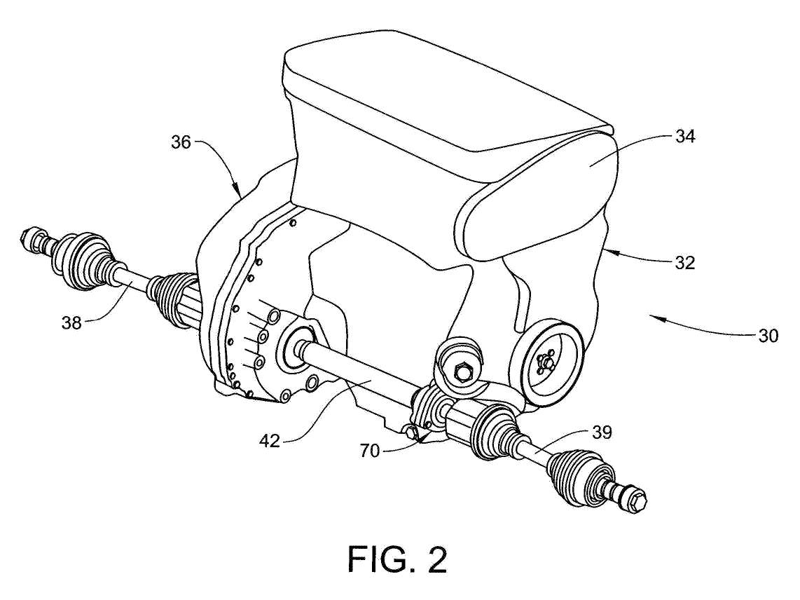

With reference to FIG. 2 and continuing reference to FIG. 1, transmission 36 includes a first output shaft 38 and a second output shaft 39. An intermediate drive shaft (IDS) 42 operatively connects transmission 36 and second output shaft 39. A half shaft (not separately labeled) may be arranged between IDS 42 and second output shaft 39. A first wheel 45 is operatively connected to first output shaft 38 and a second wheel 46 is operatively connected to second output shaft 39. Vehicle 10 also includes a third wheel 52 and a fourth wheel 56.

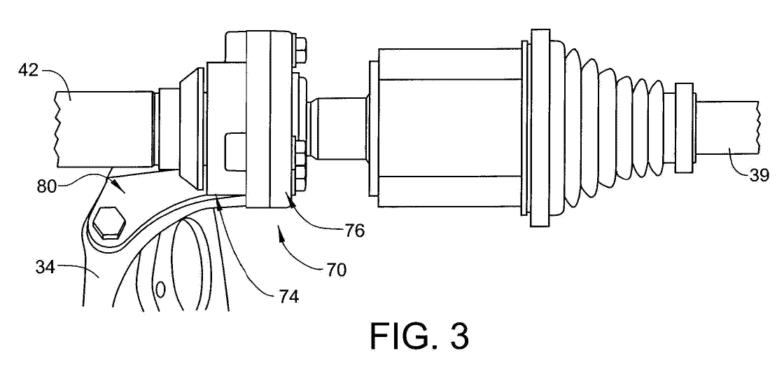

In accordance with an aspect of an exemplary embodiment, IDS 42 is rotatably supported by a self-contained oil lubricated bearing bracket system 70. Referring to FIG. 3, self-contained oil lubricated bearing bracket system 70 may include a first bracket component 74 coupled to a second bracket component 76. First bracket component 74 includes a mounting flange 80 that may be coupled to motor 34 through one or more mechanical fasteners (not separately labeled). First bracket component 74 and second bracket component 76 may collectively form a lubricant reservoir (not separately labeled) in accordance with an aspect of an exemplary embodiment.

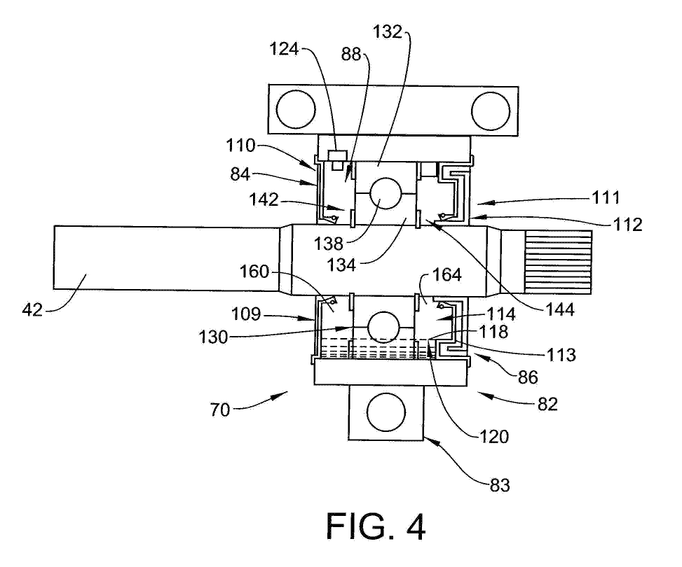

In accordance with another aspect of an exemplary embodiment, self-contained oil lubricated bearing bracket system 70 may also be formed from a single bracket component 82 having a mounting flange 83 such as shown in FIG. 4. Bracket component 82 includes a first opening 84 that aligns with second opening 86 forming a passage (not separately labeled) having an interior portion 88 that is receptive to IDS 42. A first seal 109, which may take the form of a lip seal 110, is provided at first opening 84 and seals against an outer surface (not separately labeled) of IDS 42. It is to be understood that first seal 109 may take on a variety of forms. A second seal 111, which may take the form of a cartridge seal 112 having a slinger 113 may be provided at second opening 86. Second seal 111 also seals against the outer surface of IDS 42. Second seal 111 may also take on a variety of forms.

In accordance with an aspect of an exemplary embodiment, interior portion 88 defines a lubricant reservoir 114. An amount of lubricant 118, such as oil 120, may be introduced into lubricant reservoir 114 through a vent and fill cap 124 to provide lubrication for a bearing 130. Bearing 130 includes an outer race 132 that may be fixedly connected to bracket component 82 and an inner race 134 that rotatably supports IDS 42. A plurality of bearing elements, one of which is indicated at 138, is arranged between outer race 132 and inner race 134. At rest, at least one of the plurality of bearing elements 138 is arranged in lubricant reservoir 114 and is exposed to the amount of lubricant 118. During operation, the plurality of bearing elements 138 pass through the amount of lubricant 118 in lubricant reservoir 114.

A first snap ring 142 extends about a first side (not separately labeled) of bearing 130 and a second snap ring 144 extends about a second, opposing side (also not separately labeled) of bearing 130. First snap ring 142 and second snap ring 144 maintain a selected position of bearing 130 within bracket component 82. Additional snap rings, (not separately labeled) may also be employed to retain bearing 130 within interior portion 88. A first reservoir portion 160 may be formed within the interior portion 88 on one side (not separately labeled) of bearing 130 and a second reservoir portion 164 may be formed within interior portion 88 on a second, opposing side (also not separately labeled) of bearing 130. First and second reservoir portions 160 and 164 may be fluidically connected through, for example, bearing 130 or passages (not shown) formed in bracket component 82.

It should be appreciated that the exemplary embodiments describe a bracket that not only supports a rotating shaft, but also forms a liquid lubricant reservoir that may be filled with a variety of lubricant to provide desired lubrication to a bearing. It should be understood that while described in terms of supporting an IDS, the self-contained oil lubricated bearing bracket system 70 may be employed to support a variety of rotating shafts. It should also be understood that while being described as containing oil, other forms of lubricant may be housed in the self-contained oil lubricated bearing bracket system 70 in accordance with exemplary embodiments.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A self-contained oil lubricated bearing bracket system for a vehicle comprising:
a bracket component including a body having an inner surface defining, at least in part, a first opening, a second opening, and an interior portion defining, at least in part, a lubricant reservoir; and
a bearing mounted to the bracket component, the bearing including a plurality of bearing elements, at least one of the plurality of bearing elements being arranged in the lubricant reservoir.

2. The self-contained oil lubricated bearing bracket system according to claim 1, wherein the bearing includes an outer race fixedly mounted to the inner surface, and an inner race, the plurality of bearing elements being arranged between the outer race and the inner race.

3. The self-contained oil lubricated bearing bracket system according to claim 2, further comprising: a first snap ring extending annularly about a first side of the bearing and a second snap ring extending about a second, opposing side of the bearing, the first snap ring and the second snap ring retaining the bearing in the bracket component.

4. The self-contained oil lubricated bearing bracket system according to claim 1, further comprising: a first seal extending about the first opening and a second seal extending about the second opening.

5. The self-contained oil lubricated bearing bracket system according to claim 4, wherein at least one of the first seal and the second seal comprises one of a lip seal and a cartridge seal.

6. The self-contained oil lubricated bearing bracket system according to claim 4, wherein at least one of the first seal and the second seal comprises a cartridge seal including a slinger.

7. The self-contained oil lubricated bearing bracket system according to claim 1, further comprising: a vent and fill cap arranged in the bracket component.

8. The self-contained oil lubricated bearing bracket system according to claim 1, further comprising: an amount of lubricant arranged in the lubricant reservoir.

9. The self-contained oil lubricated bearing bracket system according to claim 1, wherein the lubricant reservoir includes a first reservoir portion and a second reservoir portion, the first reservoir portion being fluidically connected with the second reservoir portion.

10. A vehicle comprising:
a frame;
a body supported by the frame;
a powertrain supported by the frame and at least partially enclosed by the body, the powertrain including a prime mover and a transmission connected to the prime mover, the transmission including at least one output shaft; and
a self-contained oil lubricated bearing bracket system rotatably supporting the at least one output shaft, the self-contained oil lubricated bearing bracket system comprising:
a bracket component including a body having an inner surface defining, at least in part, a first opening, a second opening, and an interior portion defining, at least in part, a lubricant reservoir; and
a bearing mounted to the bracket component, the bearing including a plurality of bearing elements, at least one of the plurality of bearing elements being arranged in the lubricant reservoir.

11. The vehicle according to claim 10, wherein the bearing includes an outer race fixedly mounted to the inner surface, and an inner race, the plurality of bearing elements being arranged between the outer race and the inner race.

12. The vehicle according to claim 11, further comprising: a first snap ring extending annularly about a first side of the bearing and a second snap ring extending about a second side of the bearing, the first snap ring and the second snap ring retaining the bearing in the bracket component.

13. The vehicle according to claim 10, further comprising: a first seal extending about the first opening and a second seal extending about the second opening.

14. The vehicle according to claim 13, wherein at least one of the first seal and the second seal comprises one of a lip seal and a cartridge seal.

15. The vehicle according to claim 13, wherein at least one of the first seal and the second seal comprises a cartridge seal including a slinger.

16. The vehicle according to claim 10, further comprising: a vent and fill cap arranged in the bracket component.

17. The vehicle according to claim 10, further comprising: an amount of lubricant arranged in the lubricant reservoir.

18. The vehicle according to claim 10, wherein the lubricant reservoir includes a first reservoir portion arranged on a first side of the bearing and a second reservoir portion arranged on a second, opposing side of the bearing, the first reservoir portion being fluidically connected with the second reservoir portion.

19. The vehicle according to claim 10, wherein the at least one output shaft comprises an intermediate drive shaft (IDS).

20. The vehicle according to claim 10, wherein the self-contained oil lubricated bearing bracket system is fixedly mounted to the prime mover.
